(19) United States
(12) Patent Application Publication
(10) Pub. No.: US 2005/0227545 A1
(43) Pub. Date: Oct. 13, 2005

(54) Connector for a cable comprising a plurality of twisted conductors

(75) Inventors: Carine Lahoreau, Monnaie (FR); Jean-Charles Mondot, Tours (FR)

Correspondence Address: OLIFF & BERRIDGE, PLC, P.O. BOX 19928, ALEXANDRIA, VA, 22320, US

(73) Assignee: RADIALL, Rosny-Sous-Bois (FR)

(21) Appl. No.: 11/095,618

(22) Filed: Apr. 1, 2005

(30) Foreign Application Priority Data
Apr. 7, 2004 (FR) 04.50705

(51) Int. Cl. H01R 13/502

(52) U.S. Cl. 439/695

(57) ABSTRACT

The present invention provides a connector for a cable having a plurality of insulated twisted conductors, in particular a twinaxial cable or a dual twinaxial cable, the connector comprising: at least two contact elements, each suitable for being secured to one end of a conductor of the cable; a spacer made of insulating material, having at least two open housings extending parallel to a longitudinal axis of the spacer, each of the housings being arranged to receive one end of a conductor of the cable with a contact element secured thereto; wherein, on said spacer, it includes projecting or recessed means for encouraging retention of the end of a conductor of the cable with a contact element secured thereto while they are being inserted into a housing of the spacer.

The present invention relates in particular to a connector for a cable comprising a plurality of insulated twisted conductors, in particular twinaxial or dual twinaxial cable.

### BACKGROUND OF THE INVENTION

This type of cable enables electrical signals to be transported at very high frequency, e.g. a frequency close to 1 gigahertz (GHz).

French patent application FR 2 814 598 discloses a connector for this type of cable, the connector comprising an insulator with parallel channels into which the untwisted conductors of a dual twinaxial cable are inserted, together with the contact pins secured to the ends of the conductors. Each channel comprises two facing walls that are substantially plane. The insulation serves to ensure continuity of the characteristic impedance of the cable through the connector.

Fitting the conductors of the cable to the connector is relatively complex, insofar as the conductors can spread out away from the channels while they are being put into place.

### SUMMARY OF THE INVENTION

The invention makes it possible in particular to avoid such a drawback by means of a connector for a cable comprising a plurality of insulated twisted conductors, in particular a twinaxial or a dual twinaxial cable, the connector comprising:

at least two contact elements, each suitable for being secured to one end of a conductor of the cable;

a spacer made of insulating material, having at least two open housings extending parallel to a longitudinal axis of the spacer, each of the housings being arranged to receive one end of a conductor of the cable with a contact element secured thereto;

wherein, on said spacer, it includes projecting or recessed means for encouraging retention of the end of a conductor of the cable with a contact element secured thereto while they are being inserted into a housing of the spacer.

By means of the invention, the conductors of the cable and the associated contact elements can be held in the respective housings once they have been inserted therein.

Thus, while fitting the conductors, a technician is not troubled by the risk that they might spread out from the housings into which they have been inserted, thereby making them much easier to put into place.

In an embodiment of the invention, the spacer includes at one holding portion in relief projecting from a wall of the housing.

Thus, one of the conductors of the cable together with the contact element fastened thereto can be held in the housing means of this holding portion in relief.

This holding portion in relief also makes it possible to insert a conductor of the cable together with the contact element fastened thereto into the housing by snap-fastening.

When the housing includes a longitudinal slot, the holding portion in relief may be adjacent to the slot.

Preferably, the holding portion in relief extends longitudinally over a fraction only of the slot.

When the housing includes a front portion arranged to receive a contact element, the holding portion in relief may extend only in said front portion, in particular being adjacent to an axial end of the housing.

Thus, the holding portion in relief co-operates only with the contact element when the cable conductor together with the contact element is inserted into the corresponding housing.

In a variant, the holding portion in relief extends over the entire length of the slot.

Advantageously, the housing comprises two facing wall portions, in particular parallel portions, with at least one, and preferably both, of them having a holding portion in relief that is preferably located facing the other wall portion.

The holding portion in relief preferably extends over a fraction only of the depth of the corresponding housing.

The spacer has a core and advantageously presents a rear setback opening out into the housings of the spacer and into which the twisted conductors of the cable are inserted so as to spread out towards the core of the spacer.

The cable presents a zone in which the conductors change from a twisted state to a non-twisted state, with the spacing between them increasing and with the core of the spacer being engaged in said increased spacing.

By the presence of the above-mentioned setback, the invention enables the spacer to be pressed home into abutment against the shielding braid of the cable, thereby improving the accuracy with which the cable is positioned in the connector.

Advantageously, the setback is circularly symmetrical over a predetermined angle, e.g. an angle of 90° about the longitudinal axis of the spacer.

The setback may be substantially frustoconical in shape, tapering towards the front of the spacer.

In a variant, the setback may be substantially cylindrical in shape, having a generator line parallel to the longitudinal axis of the spacer.

The bottom of the setback may be substantially flat, or in a variant it may present a projection formed by the core of the spacer.

In an embodiment of the invention, the spacer has an outer wall that is substantially circularly cylindrical, and in particular that does not have a collar.

The spacer may be made as a single piece, in particular by molding a plastics material.

The invention also provides a connector for a cable having a plurality of insulated twisted conductors, in particular a twinaxial cable or a dual twinaxial cable, the connector comprising:

at least two contact elements, each suitable for being secured to one end of a conductor of the cable; and

a spacer made of an insulating material, having at least two housings extending parallel to a longitudinal axis of the spacer, each of these housings being arranged to receive one end of a conductor of the cable together with a contact element secured thereto;

wherein the spacer includes at least one holding portion in relief projecting from a wall of the housing.

The invention also provides a connector for a cable having a plurality of insulated twisted conductors, in particular a twinaxial cable or a dual twinaxial cable, the connector comprising:

at least two contact elements, each suitable for being secured to one end of a conductor of the cable; and

a spacer made of insulating material, having at least two housings extending parallel to a longitudinal axis of the spacer, each of these housings being arranged to receive one end of a conductor of the cable together with a contact element fastened thereto, the spacer presenting a rear portion against which the twisted conductors of the cable are pressed, the spacer also having a core;

wherein, in said rear portion, the core of the spacer forms a setback opening out into the housings of the spacer.

### BRIEF DESCRIPTION OF THE DRAWINGS

The invention can be better understood on reading the following detailed description of non-limiting embodiments of the invention, and on examining the accompanying drawings, in which:

FIG. 1 is a diagrammatic and fragmentary longitudinal section view of two assembled-together connectors in accordance with the invention, one male and the other female;

FIG. 2 is a diagrammatic and fragmentary exploded view of the female connector of FIG. 1;

FIG. 3 is a diagrammatic and fragmentary perspective view showing the spacer of the FIG. 2 connection in isolation;

FIG. 4 is a diagrammatic and fragmentary section view on IV-IV showing the FIG. 3 spacer;

FIG. 5 is a diagrammatic and fragmentary section view on V-V showing the FIG. 3 spacer; and

FIGS. 6 to 9 are diagrammatic and fragmentary views respectively in longitudinal section and in perspective showing two spacers constituting two variant embodiments of the invention.

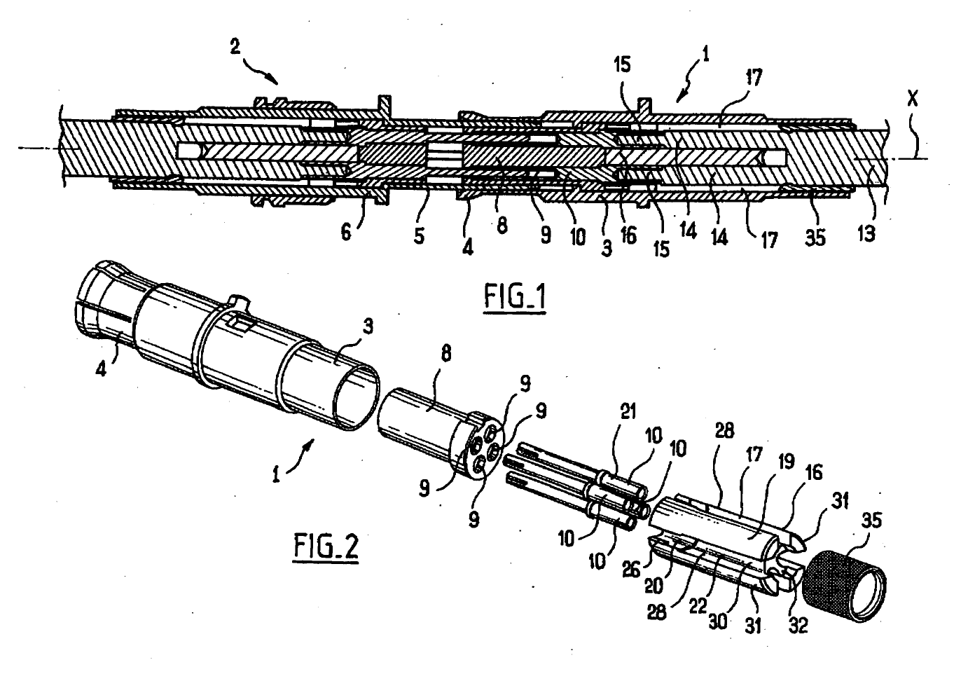

FIG. 1 shows a female connector 1 in accordance with the invention assembled with a male connector 2 in accordance with the invention.

### MORE DETAILED DESCRIPTION

The connector 1 comprises an outer body 3 having, at its front end, a female connection portion 4 suitable for co-operating with a male connection portion 5 of an outer body 6 of the male connector 2.

The connector 1 further comprises an insulating body 8 pierced by bores 9, there being four bores in the example described, each arranged to receive a respective contact element 10.

The connector 1 is secured to the end of a dual twinaxial cable 13 having four insulated twisted conductors 14, as shown diagrammatically in FIG. 1.

Each conductor 14 presents an untwisted end 5 secured to a contact element 10.

The end 15 of each conductor 14 having the contact element 10 secured thereto is inserted in a housing 17 of a spacer 16.

The spacer 16 is made as a single piece of insulating material, e.g. of thermoplastic material.

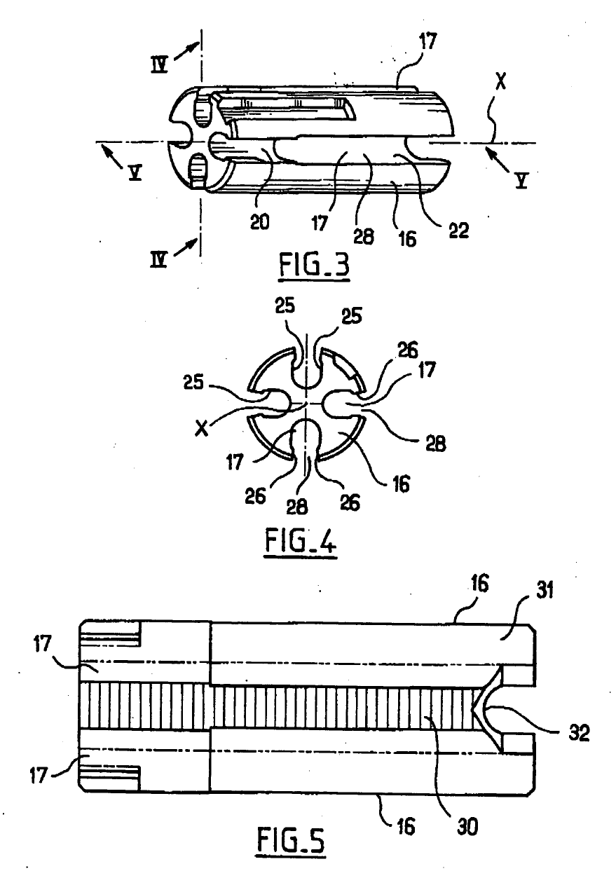

The spacer 16 presents an outer wall 19 that is substantially circularly cylindrical about the axis X, and it has four housings 17 parallel to the axis X, these housings being uniformly distributed angularly around the axis X, as can be seen in FIGS. 3 and 4, in particular.

Each housing 17 also has a front portion 20 for receiving the rear portion 21 of a contact element 10, and a rear portion 22 of cross-section that is slightly greater than that of the front portion 10 for the purpose of receiving an untwisted length of conductor 14.

In the front portion 20, each housing 17 has two substantially parallel longitudinal wall portions 25, with each of these wall portions 25 being provided with a holding portion 26 in relief facing the other holding portion 26 in relief. These portions 26 in relief are adjacent to a longitudinal slot 28 of the housing 17 and to the front end of the spacer 16, and they extend over a fraction only of the length of the housing 17. Each longitudinal slot 28 extends over the entire length of the spacer 16.

In a variant, the holding portions 26 in relief may extend over the entire length of the corresponding housing 17, for example.

Each portion 26 in relief extends over a fraction only of the depth of the front portion 20.

The diameter of the rear portions 21 of the contact elements 10 is slightly greater than the distance between two facing portions 26 in relief, such that the contact element 10 is inserted by snap-fastening in the front portion 20.

Preferably, the section of the housing beneath the portions 26 in relief is selected so as to allow the rear portions 21 of the contact elements 10 to slide axially.

Once the untwisted conductors 14 together with the contact elements 10 secured thereto have been inserted, these portions 26 in relief also serve to oppose the conductors 14 flaring out from the housings 17.

Thus, when a technician is fitting the cable 13 to the connector 1, there is no need to worry about keeping the untwisted conductors 14 in the corresponding housings 17.

The spacer 16 has a central core 30 extending along the axis X and co-operating with four perpendicular portions 31 to define the housings 17.

In the example shown, in the rear portion of the spacer 16, the core 30 forms a setback 32 of frustoconical shape that converges towards the front of the spacer, as shown in FIG. 5.

This setback 32 opens out into the longitudinal housings 17.

In the example described, the setback 32 is circularly symmetrical over an angle of 90° about the axis X.

While the conductors 14 are being put into place in the respective housings 17, this setback 32 makes it possible to push the spacer home into abutments onto a shielding braid of the cable, and to position the cable properly in the connector.

A ferrule 35 is provided for securing around the cable 13.

Naturally, the invention is not limited to the embodiment described above.

The setback 32 could be of a shape other than that described above.

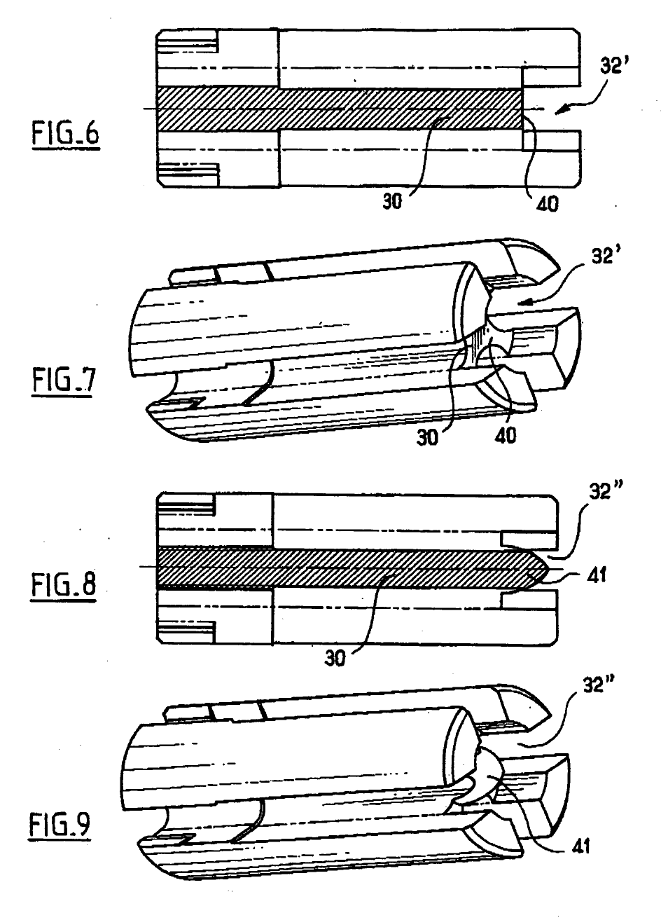

As shown in FIGS. 6 and 7, the spacer could present a rear setback 32′ that is substantially cylindrical in shape, having a generator line parallel to the axis X and having a bottom formed by a plane transverse wall 40 of the core 30.

In a variant, as shown in FIGS. 8 and 9, the setback 32″ presents a bottom with a projection 41 formed by the core 30 of the spacer.

1. A connector for a dual twinaxial cable having a plurality of insulated twisted conductors, the connector comprising:
a plurality of contact elements, each suitable for being secured to one end of a conductor of the cable; and
a spacer made of an insulating material presenting an outer wall that is substantially circularly cylindrical about a longitudinal axis, the spacer having four open housings extending parallel to the longitudinal axis of the spacer and uniformly distributed angularly around said longitudinal axis, each housing being arranged to receive one end of a conductor of the cable together with a contact element secured thereto;
wherein said spacer includes projecting or recessed means for facilitating retention of the end of a conductor of the cable with a contact element secured thereto when said ends are inserted in respective housings of the spacer.

2. A connector according to claim 1, wherein the spacer includes at least one holding portion in relief projecting from a wall of the housing.

3. A connector according to claim 2, wherein the housing includes a longitudinal slot, and wherein said holding portion in relief is adjacent to said slot.

4. A connector according to claim 3, wherein said holding portion in relief extends longitudinally over a fraction only of the slot.

5. A connector according to claim 2, wherein the housing includes a front portion arranged to receive a contact element, and wherein the holding portion in relief extends only over said front portion, being in particular adjacent to an axial end of the housing.

6. A connector according to claim 2, wherein the housing has two facing wall portions, in particular parallel wall portions with at least one of them, and in particular each of them, having a holding portion in relief preferably placed facing the other wall portion.

7. A connector according to claim 2, wherein the holding portion in relief extends over a fraction only of the depth of the corresponding housing.

8. A connector according to claim 1, wherein the spacer has a core, and presents a rear setback opening out into the housings, and into which the twisted conductors of the cable are inserted so as to splay apart going towards the core of the spacer.

9. A connector according to claim 8, wherein the setback is substantially cylindrical in shape having a generator line parallel to the longitudinal axis of the spacer.

10. A connector according to claim 9, wherein the setback presents a bottom that is substantially flat.

11. A connector according to claim 9, wherein the core of the spacer forms a projection extending in the setback.

12. A connector according to claim 1, wherein the spacer is made as a single piece.

13. A connector for a dual twinaxial cable having a plurality of insulated twisted conductors, the connector comprising:
a plurality of contact elements, each suitable for being secured to one end of a conductor of the cable; and
a spacer made of an insulating material comprising an outer wall that is substantially circularly cylindrical about a longitudinal axis, the spacer comprising four open housings extending parallel to the longitudinal axis of the spacer and uniformly distributed angularly around said longitudinal axis, each housing being configured to receive one end of a conductor of the cable together with a contact element secured thereto;
wherein the spacer has a core, and comprises a rear setback opening out into the housings and into which the twisted conductors of the cable are inserted so as to splay apart going towards the core of the spacer.

14. A connector for a dual twinaxial cable having a plurality of insulated twisted conductors, the connector comprising:
a plurality of contact elements, each suitable for being secured to one end of a conductor of the cable; and
a spacer made of an insulating material presenting an outer wall that is substantially circularly cylindrical about a longitudinal axis, the spacer having four open housings extending parallel to the longitudinal axis of the spacer and uniformly distributed angularly around said longitudinal axis, each housing being configured to receive one end of a conductor of the cable together with a contact element secured thereto;
wherein the spacer comprises at least one holding portion in relief projecting from a wall of the housing.

15. A connector according to claim 12, wherein the spacer is made by molding a plastic material.
